(19) United States
(12) Patent Application Publication
(10) Pub. No.: US 2017/0025775 A1
(43) Pub. Date: Jan. 26, 2017

(54) CONNECTOR ADOPTING PCB AND PCB EDGE PLATING

(71) Applicant: Amphenol East Asia Electronic Technology (Shenzhen)co., Ltd., Shenzhen (CN)

(72) Inventors: Fu-An JIANG, Shenzhen (CN); Lei LIAO, Shenzhen (CN)

(21) Appl. No.: 14/805,958

(22) Filed: Jul. 22, 2015

(51) Int. Cl. H01R 12/79

(52) U.S. Cl. CPC H01R 12/79

(57) ABSTRACT

The present invention discloses a connector adopting PCB and PCB edge plating, which includes a frame element and a transmission element; the frame element includes main body assembly, and the main body assembly includes a protrusion and a power terminal slot; the transmission element includes a terminal assembly and a PCB connection assembly; the terminal assembly includes a first signal terminal set, a second terminal set, a first power terminal set and a second power terminal set; the PCB connection assembly includes a first terminal contact area and a second terminal contact area.

### CROSS-REFERENCE TO RELATED APPLICATIONS

Not applicable

### BACKGROUND OF THE INVENTION

1. Field of the Invention

The present invention generally relates to a connector, in particular to a connector adopting PCB and PCB edge plating.

2. Description of the Related Art

With the increase of the technique standard and requirements, the thickness of the joint of the signal terminal of a connector is required to be thinner; however, the thickness of the signal terminals of the currently available connectors is very hard to be thinner; if the thickness of the signal terminals of the currently available connectors is made to be thinner, the transmission will become unstable.

### BRIEF SUMMARY OF THE INVENTION

The technical problems which the present invention wants to solve are: the present invention provides a connector adopting PCB and PCB edge plating, which directly connects the connector with a PCB; besides, the connector also adopts the PCB edging plating frequently used to manufacture high-speed RF board. The present invention can not only simplify the manufacturing process of the connector, but also increase the transmission speed.

In order to solve the above technical problems, the present invention provides a connector adopting PCB and PCB edge plating, which includes a frame element and a transmission element; the frame element includes main body assembly, and the main body assembly includes a protrusion and a power terminal slot; the transmission includes a terminal assembly and a PCB connection assembly; the terminal assembly includes a first signal terminal set, a second terminal set, a first power terminal set and a second power terminal set; the PCB connection assembly includes a first terminal contact area and a second terminal contact area.

The terminal assembly is inserted in the main body assembly, wherein the first signal terminal set includes a first signal terminal and a grounding terminal, which are respectively connected to the first terminal contact area and the second terminal contact area; the second signal terminal set includes a second signal terminal and a grounding terminal, which is connected to the first terminal contact area; the first power terminal set includes a first signal terminal and a grounding terminal, which is connected to the second terminal contact area; the first terminal contact area and the second terminal contact area are respectively disposed at the two ends of the PCB connection assembly, and the connection end of the PCB connection assembly includes a plating layer.

In a preferred embodiment of the present invention, the main body assembly includes the protrusion and the power terminal slot; the protrusion is disposed at the center of the main body assembly and the power terminal slot is disposed on the protrusion.

In a preferred embodiment of the present invention, the second power terminal set is inserted into the power terminal slot; the output power or input power of the power supply can increase by means of the second power terminal set.

In a preferred embodiment of the present invention, the PCB connection assembly includes a blind hole and a GND layer; the grounding terminal includes a blind hole protrusion; the blind hole is disposed on the PCB connection assembly and corresponding to the position of the blind hole of the grounding terminal; the grounding terminal is directly connected to the GND layer by connecting the blind hole and the blind hole protrusion, which can improve the high-speed transmission performance of the connector.

In a preferred embodiment of the present invention, the grounding terminal includes long PIN type grounding terminals; the PCB connection assembly includes a plating layer, and the plating layer connects the long PIN type grounding terminals with one another, which can further improve the high-speed transmission performance of the connector. The plating layer is related to PCB edge plating, which is frequently used to manufacturing high-speed RF board or antenna. PCB edge plating can effectively connect the long PIN type grounding terminals with one another to improve the transmission performance.

In a preferred embodiment of the present invention, the frame element includes a welding plate assembly and the welding plate assembly is disposed at two end of the main body assembly.

The connector adopting PCB and PCB edge plating according to the present invention has the following advantages:

Compared with prior art, the connector adopting PCB and PCB edge plating according to the present invention can not only simplify the manufacturing process, but also can increase the transmission speed; in the above preferred embodiments, the second power terminal set can increase the input power and output power of the power supply; in the above preferred embodiments, the grounding terminal is directly connected to the GND layer, which can increase the high-speed transmission performance of the connector; in the above preferred embodiments, the connection end of the PCB connection assembly adopts PCB edge plating to connect the grounding terminals with one anther, which can further improve the high-speed transmission performance.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is the assembly drawing of the connector with PCB in according to the present invention.

FIG. 2 is the breakdown drawing of the connector with PCB in according to the present invention.

### DETAILED DESCRIPTION OF THE INVENTION

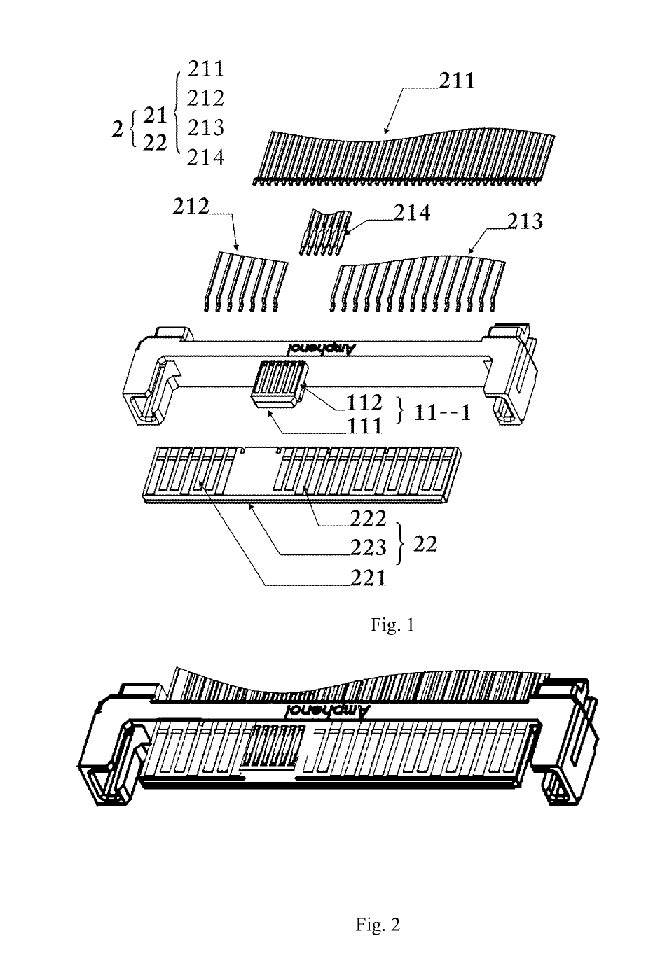

The technical content of the present invention will become apparent by the detailed description of the following embodiments and the illustration of FIG. 1 and FIG. 2 as follows. However, the present invention will not be limited by the following description and the drawings.

Please refer to FIG. 1 and FIG. 2, which shows the connector adopting PCB and PCB edge plating according to the present invention. The connector includes a frame element 1 and a transmission element 2; the frame element 1 includes a main body assembly 11; the main body assembly 11 includes a protrusion 111 and a power terminal slot 112; the transmission element 2 includes a terminal assembly 21 and a PCB connection assembly 22; the terminal assembly 21 includes a first signal terminal set 211, a second terminal set 212, a first power terminal set 213 and a second power terminal set 214; the PCB connection assembly 22 includes a first terminal contact area 221 and a second terminal contact area 222.

The terminal assembly 21 is inserted in the main body assembly 11, wherein the first signal terminal set 211 includes a first signal terminal and a grounding terminal, which are respectively connected to the first terminal contact area 221 and the second terminal contact area 222; the second signal terminal set 212 includes a second signal terminal and a grounding terminal, which is connected to the first terminal contact area 221; the first power terminal set 213 includes a first signal terminal and a grounding terminal, which is connected to the second terminal contact area 222; the first terminal contact area 221 and the second terminal contact area 222 are respectively disposed at the two ends of the PCB connection assembly 22; the connection end of the PCB connection assembly includes a plating layer.

Based on the above embodiment, the main body assembly includes the protrusion 111 and the power terminal slot 112; the protrusion 111 is disposed at the center of the main body assembly 11 and the power terminal slot 112 is disposed on the protrusion 111.

Based on the above embodiment, the second power terminal set 214, is inserted into the power terminal slot 112.

Based on the above embodiment, the PCB connection assembly 22 includes a blind hole and a GND layer; the grounding terminal includes a blind hole protrusion; the blind hole is disposed on the PCB connection assembly 22 and corresponding to the position of the blind hole of the grounding terminal; the grounding terminal is directly connected to the GND layer by connecting the blind hole and the blind hole protrusion.

Based on the above embodiment, the grounding terminal includes a long PIN type grounding terminal; the PCB connection assembly 22 includes a plating layer 223, and the plating layer 223 is connected to the long PIN type grounding terminal The plating layer is related to PCB edge plating, which is frequently used to manufacturing high-speed RF board or antenna. PCB edge plating can effectively connect the long PIN type grounding terminals with one another to improve the transmission performance.

Based on the above embodiment, the frame element 1 includes a welding plate assembly and the welding plate assembly is disposed at the two ends of the main body assembly 11.

Based on the above embodiment, after the terminal assembly 21 is connected to the PCB, the joint of the terminal assembly and the PCB can be coated by a shielding layer to shield the signals so as to prevent from the mutual interference between the signals or the currents of the power supply.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A connector adopting PCB and PCB edge plating, comprising frame element and transmission element, wherein the frame element further comprises a main body assembly; the main body assembly further comprises a protrusion and a power terminal slot; the transmission element further comprises a terminal assembly and a PCB connection assembly; the terminal assembly further comprises a first signal terminal set, a second signal terminal set and a first power terminal set; the PCB connection assembly further comprises a first terminal contact area and a second terminal contact area;
wherein the first signal terminal set comprises a first signal terminal and a grounding terminal respectively connected to the first terminal contact area and the second terminal contact area;
wherein the second signal terminal set comprises a second signal terminal and a grounding terminal, and is connected to the first terminal contact area;
wherein the first power terminal set comprises a first signal terminal and a grounding terminal, and is connected to the second terminal contact area;
wherein the first terminal contact area and the second terminal contact area are respectively disposed at two ends of the PCB connection assembly; and
wherein a connection end of the PCB connection assembly includes a plating layer.

2. The connector of claim 1, said main body assembly comprises the protrusion and the power terminal slot; and the protrusion is disposed at a center of the main body assembly and the power terminal slot is disposed on the protrusion.

3. The connector of claim 2, said terminal assembly comprises a second power terminal set, and the second power terminal set is inserted into the power terminal slot.

4. The connector of claim 1, said PCB connection assembly comprises a blind hole and a GND layer; the grounding terminal comprises a blind hole protrusion; the blind hole is disposed on the PCB connection assembly and corresponds to a position of the blind hole of the grounding terminal; the grounding terminal is directly connected to the GND layer by connecting the blind hole and the blind hole protrusion.

5. The connector of any one of claims 1, 2, 3 and 4, said grounding terminal comprises long PIN type grounding terminals; the PCB connection assembly comprises a plating layer, and the plating layer connects the long PIN type grounding terminals with one another.

6. The connector of any one of claims 1, 2, 3 and 4, said frame element comprises a welding plate assembly and the welding plate assembly is disposed at two ends of the main body assembly.
